(19) United States
(12) Patent Application Publication
(10) Pub. No.: US 2019/0116341 A1
(43) Pub. Date: Apr. 18, 2019

(54) SMART SENSOR APPARATUS

(71) Applicant: ALFAPLUS SEMICONDUCTOR INC., Hsinchu City (TW)

(72) Inventor: Po-Shaw HUANG, Hsinchu City (TW)

(21) Appl. No.: 15/784,707

(22) Filed: Oct. 16, 2017

(51) Int. Cl. H04N 7/18; H04N 5/232

(52) U.S. Cl. CPC H04N 7/183; H04N 5/23206

(57) ABSTRACT

A smart sensor apparatus comprises at least one micro-function box and a micro-camera device. The micro-function box is placed at a position in a same detection space or individually placed at position in different detection spaces. The micro-function box comprises a sensor that is built-in with environmental or health monitoring parameters corresponding to the corresponding detection space. The micro-camera device is connected to the above micro-function box and includes an image capturing unit and a micro control unit (MCU) connected to the camera unit. After the image capturing unit captures two or more consecutive frames from the sensor of the micro-function box, the MCU compares changes in pixels of the two or more consecutive frames to detect and collect environmental and health monitoring data generated from the detection space.

### BACKGROUND OF THE INVENTION

### Field of the Invention

The present invention relates to a smart sensor apparatus, which is similar to Lego™ blocks capable of assembling in a repeat way, is formed by integrating one same micro-camera device with different micro-function boxes to provided different uses.

### Description of the Related Art

Concepts of smart homes have been developed and promoted in the recent years, achieving home-based cores and therefrom extended applications in the fields of environment, medical care, security, caretaking and power saving. To achieve the goal of smart homes, household automation systems are essentially one of the cores. Household automation systems are an integration of network monitoring systems combined with micro-processing technologies and embedded products, and so as to automatically control and manage household electronic appliances in a centralized way and systems. Among various household automation systems, detection and tracking technologies for moving objects are prevalent.

It is known from the above that, effective motion detection and tracking technologies for moving objects are critical in the achievement of smart homes. With the evolving technologies, methods for motion detection are becoming more and more diversified, and positioning and tracking of objects have always been focal discussion topics. In the prior art, to achieve the goal of smart homes needs many different types of sensors to collect different environmental and health data for comprehensive analysis. However, due to the involvement of interdisciplinary technologies that need immense resources, manufacturing different types of sensors in a cross-industry manner is extremely challenging for one single company.

### SUMMARY OF THE INVENTION

It is a primary object of the present invention to provide a solution of a smart sensor formed by combining the same micro-camera device with different micro-function boxes, so as to provide different uses. The smart sensor of the present invention attends to most of current methods for manufacturing smart sensors, and is a solution for replacing current home sensor solutions having unsatisfactory efficiency.

It is another object of the present invention to provide a solution using a smart sensor of the present invention to allow one single company to encompass various sensors in a cross-industry manner. Micro-function boxes and various sensors therein can be intelligently 3D printed, saving even costs of producing molds.

To achieve the above objects, the present invention provides a smart sensor apparatus comprising at least one micro-function box and a micro-camera device. The micro-function box is placed at a position in a same environment or individually placed at positions in different environments that need to be detected. The micro-function box comprises therein a sensor, which is built-in with environmental or health monitoring data corresponding to the detection space(s). The micro-camera is connected to the micro-function box, and comprises an image capturing unit and a micro processing unit (MCU) connected to the image capturing device. After the image capturing unit captures two or more consecutive frames of the sensor in the micro-function box, the MCU compares changes in pixels of the two or more consecutive frames, so as to detect and collect environmental and health monitoring data generated from the detection space(s).

In implementation, the micro-camera device further includes a wireless module to form a wireless smart sensor apparatus.

In implementation, the MCU may be hardware of an application-specific integrated circuit (ASIC) or of a field-programmable gate array (FPGA).

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 a structural diagram of a smart sensor apparatus according to an embodiment of the present invention; and

FIG. 2 is another structural diagram of a smart sensor according to an embodiment of the present invention.

### DETAILED DESCRIPTION OF THE INVENTION

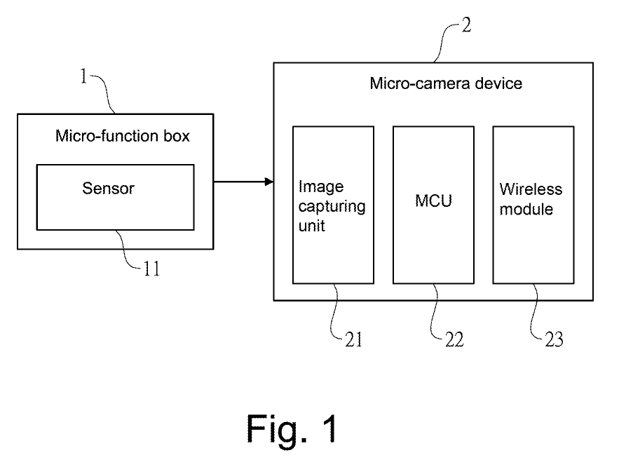

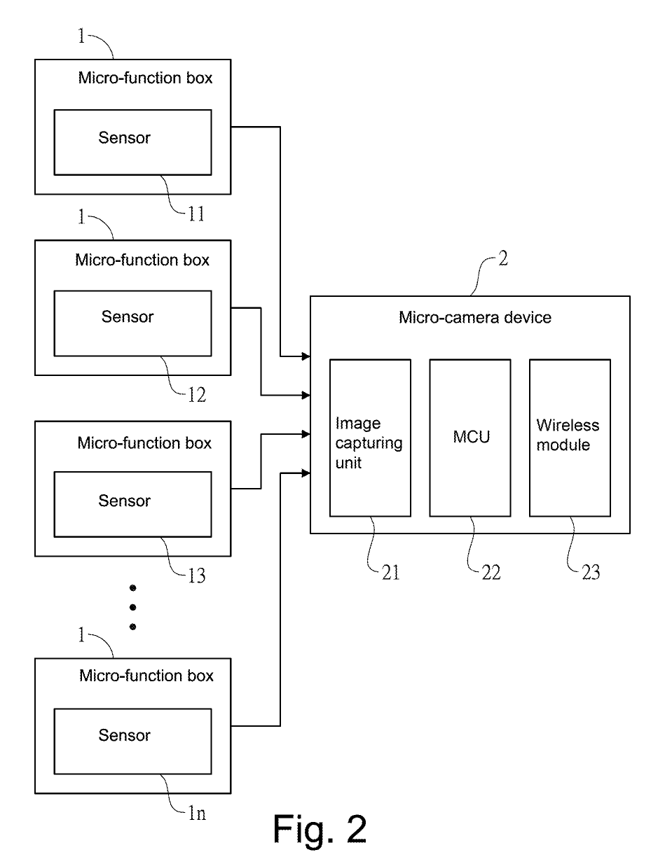

Referring to FIG. 1 and FIG. 2, a smart sensor apparatus according to an embodiment of the present invention comprises a micro-function box 1 and a micro-camera device 2.

The micro-function box 1 is placed at a position in a detection space to be detected, and includes therein a sensor 11. The sensor 11 is built-in with an environmental or health monitoring parameter corresponding to the detection space. The micro-camera device 2 is connected to the above micro-function box 1, and includes an image capturing unit 21 and a micro control unit (MCU) 22 connected to the image capturing unit 21. The MCU 22 may be hardware of an application-specific integrated circuit (ASIC) or of a field-programmable gate array (FPGA). After the image capturing unit 21 captures two or more consecutive frames from the sensor 11 in the micro-function box 1, the MCU 22 compares changes in pixels of the two or more consecutive frames to detect and collect environmental or health monitoring data generated from the detection space. For example, the micro-function box 1 is disposed in form of a black-and-white tag adhered to the glass of a window, and the micro-camera device 2 may be assembled to form a smart sensor apparatus that detects an invader through the window. Thus, when the window is invaded by an invader, after the image capturing unit 21 captures multiple consecutive frames from the sensor 11 in the micro-function box 1, the MCU 22 compares the changes in the pixels of the multiple consecutive frames to learn that changes have occurred in the environmental monitoring data, so as to determine whether an invader is present or not. Further, given that the connection between the micro-function box 1 and the micro-camera device 2 allows visual differences of the environmental or health monitoring parameters displayed by the micro-function box to be detected by the micro-camera device 2, all variations in the connection are to be encompassed within the scope of the present invention.

Further, as shown in FIG. 2, the micro-camera device 2 may be connected to a plurality of micro-function boxes 1 that are respectively placed at positions that need to be detected in different detection spaces. The micro-function boxes 1 include sensors 11, 12, 13 . . . and 1n, respectively. The sensors 11, 12, 13 . . . and 1n may have different modes. These sensors 11, 12, 13 . . . and 1n in the micro-function boxes 1 may be built-in with environmental or health monitoring parameters corresponding to the detection spaces, respectively (the monitoring parameters are not limited to visual differences of environmental or health monitoring parameters, and all visual differences that can be detected by the micro-camera device 2 are to be encompassed within the scope of the present invention), such that the visual differences of the environmental or health monitoring parameters corresponding to the detection spaces can be displayed by the sensors 11, 12, 13 . . . and 1n respectively and can be detected by the micro-camera device 2. For example, an abnormal-action smart sensor apparatus may be formed by integrating an inertial mass ball micro-function box, a flood smart sensor apparatus by integrating a specific tube-shape micro-function box, a humidity smart sensor apparatus may be formed by integrating a special paper (that shows a watermark when moistened) micro-function box, a Parkinson's monitoring shoe may be formed by integrating a 3D mass ball micro-function box, and a fire detection smart sensor apparatus may be formed by integrating another micro-function box. Thus, different smart sensors can be formed by combining the same micro-camera device 1 with different micro-function boxes. After the image capturing unit 21 captures two or more consecutive frames by using the sensors 11, 12, 13 . . . and 1n in the respective micro-function boxes 1, the MCU 22 compares the changes in the pixels of the two or more consecutive frames to detect and collect the environmental or health monitoring parameters generated from the different detection spaces, to accordingly determine whether an abnormal situation has occurred to universally satisfy all kinds of monitoring purposes.

Further, according to the present invention, the current micro-camera device 2 may be combined with a wireless module 23 to be manufactured into a wireless smart sensor apparatus having different functions. Further, the present invention may form a map in digital 0 and digital 1 directly through conversion of frames, further simplifying and reducing processing costs of digital signals.

Therefore, the present invention provides following advantages.

1. A smart sensor apparatus having one function is formed by combining the same camera device with one micro-function box, the smart sensor apparatus proving another function is formed by combining the same micro-camera device 1 with another micro-function box, and so forth. Thus, various types of micro-function boxes can be readily plugged and used to satisfy cross-industry applications.

2. The principle of the present invention is to capture two or more consecutive frames in a micro-function box by a micro-camera device, and comparing changes in pixels of the two or more consecutive frames. From the changes in the pixels, predetermined pixel parameter changes can be obtained, which is an effective means for obtaining data outputted from the micro-function box. With such powerful visual system available, most environmental and health monitoring parameters can be detected and collected through the visual design of the sensor of the micro-function box. By designing different types of sensors of the micro-function box, approaches of most conventional sensors can be replaced by the technology of the present invention.

While the invention has been described by way of example and in terms of the preferred embodiments, many modifications and variations can be deduced and arrived at based on the disclosure or teaching of the application. It is to be understood that these modifications and variations are equivalences of the concept of the present invention, and the provided effects are encompassed within the substantial spirit of the specification and drawings of the application and are thus regarded being within the scope of the technologies of the present invention.

In conclusion, based on the contents of the above disclosure, the present invention achieves expected objects, and provides a smart sensor apparatus offering practicality and values for industry use.

What is claimed is:

1. A smart sensor apparatus, comprising:
at least one micro-function box, placed at a position that needs to be detected in a detection space, the micro-function box comprising a sensor, the sensor built-in with an environmental or health monitoring parameter corresponding to the detection space; and
a micro-camera device, connected to the micro-function box, the micro-camera device comprising an image capturing unit and a micro controlling unit connected to the image capturing unit; wherein, after the image capturing unit captures two or more consecutive frames from the sensor in the micro-function box, the micro controlling unit compares changes in pixels of the two or more consecutive frames, so as to detect and collect environmental and health monitoring data generated from the detection space.

2. A smart sensor apparatus, comprising:
a plurality of micro-function boxes, respectively placed at position that need to be detected in different detection spaces, each micro-function box comprising a sensor, the sensor built-in with an environmental or health monitoring parameter corresponding to the detection space; and
a micro-camera device, connected to the plurality of micro-function boxes respectively, the micro-camera device comprising an image capturing unit and a micro controlling unit connected to the image capturing unit; wherein, after the image capturing unit captures two or more consecutive frames from the sensor in each micro-function box, the micro controlling unit compares changes in pixels of the two or more consecutive frames to detect and collect environmental and health monitoring data generated from the different detection spaces.

3. The smart sensor apparatus according to claim 2, wherein the micro-camera device further comprises a wireless module to form a wireless smart sensor apparatus.

4. The smart sensor apparatus according to claim 2, wherein the micro controlling unit is a hardware of an application-specific integrated circuit (ASIC) or of a field-programmable gate array (FPGA).

5. The smart sensor apparatus according to claim 1, wherein the micro-camera device further comprises a wireless module to form a wireless smart sensor apparatus.

6. The smart sensor apparatus according to claim 1, wherein the micro controlling unit is a hardware of an application-specific integrated circuit (ASIC) or of a field-programmable gate array (FPGA).
